(19) United States
(12) Patent Application Publication
(10) Pub. No.: US 2003/0110704 A1
(43) Pub. Date: Jun. 19, 2003

(54) Automatic closing guarding fence

(76) Inventor: Huang-Yi Cheng, Chia-I (TW)

Correspondence Address: BIRCH STEWART KOLASCH & BIRCH, PO BOX 747, FALLS CHURCH, VA, 22040-0747, US

(21) Appl. No.: 10/318,041

(22) Filed: Dec. 13, 2002

(30) Foreign Application Priority Data
Dec. 14, 2001 (TW) 090222050

(51) Int. Cl. E06B 3/32

(52) U.S. Cl. 49/463

(57) ABSTRACT

An automatic closing guarding fence has a door and an anchor frame pivotally coupled with each other on an upper pivotal position and a lower pivotal position. The axis connecting the upper pivotal position and the lower pivotal position inclines at a selected angle relative to the anchor frame such that when the door is opened, the door can swing back and close automatically due to its own weight. A release mechanism is provided to create automatic latching and closing. The structure provides convenience and improves safety to prevent risks that might otherwise occur due to adults' negligence.

### FIELD OF THE INVENTION

The invention relates to guarding fences that have a door with an upper and a lower pivotal position aligned not on the same straight line to enable the door to be closed and latched automatically by its own weight.

### BACKGROUND OF THE INVENTION

Small children are often very energetic and curious. Parents cannot accompany them all the time. In addition, many families have a limited living space. In order to protect children and prevent dangerous situations from occurring when the parents are not around, the parents often have to confine the children in a restrictive space to guard them from exposure to risky areas such as staircases. A general crib is too small and the child confined in it easily becomes bored and annoyed. Hence many parents erect a guarding fence to block the door temporarily and to confine the children in a room so that the children can be prevented from going or crawling out to avoid danger.

U.S. Pat. No. 5,704,164 discloses a foldable fence that mainly includes a pair of telescopic tubes, a stopping side and packing means located on two ends of the telescopic tubes. When in use, the telescopic tubes may be adjusted to a width matching the door, and the packing means may be used to press the fence on the inner side of the door to prevent the child from leaving the room. However, the structure is difficult to use. Every time the parent enters or leaves the room, the packing has to be folded and deployed again, which is troublesome.

U.S. Pat. No. 5,809,694 discloses a nursery gates that has an anchor base located on the inner side of the door to pivotally hinge a movable door. A latch mechanism is provided to latch the door on the base. The door may be opened by releasing the latch mechanism. While it remedies the operational problems of the previous structure, its convenience may make parents inadvertently leave the door open or not close the door securely, and may result in the children leaving the room easily.

### SUMMARY OF THE INVENTION

The primary object of the invention is to resolve the aforesaid disadvantages occurring with the conventional guarding fences or gates that have complicated operations and structural shortcomings and tend to create dangerous situations for children because of adults' negligence. The guarding fence of the invention mainly includes an anchor frame fixedly mounted on the inner side of the door frame through a packing structure. A door is pivotally engaged with one side of the anchor frame. There is a release mechanism located between the anchor frame and the door to control opening or closing of the door. The main feature of the invention is that the center axis of the upper pivotal position and the lower pivotal position for coupling the door and the anchor frame inclines at a selected angle such that when the door is opened, the door automatically swings back due to its own weight, and the release mechanism automatically latches the door in a closed position. Thus the structure of the invention can provide convenience and enhance safety to prevent risks resulting from adults' negligence.

Another object of the invention is to provide an extension spring or torsional spring between the anchor frame and the door to increase the returning force of the door.

The foregoing, as well as additional objects, features and advantages of the invention will be more readily apparent from the following detailed description, which proceeds with reference to the accompanying drawings. The drawings and the embodiment are only to serve for reference and illustrative purposes, and are not intended to limit the scope of the invention.

### BRIEF DESCRIPTION OF THE DRAWINGS

FIG. 1 is a perspective view of the invention.

FIG. 2 is an exploded view of the invention.

FIG. 3 is a front view and a top view of the invention.

FIG. 4 is a schematic view of the invention in a moving condition.

FIG. 4A is a fragmentary enlarged view of the release mechanism of the invention.

FIG. 5 is a schematic view of the structural principle of the invention.

### DESCRIPTION OF THE PREFERRED EMBODIMENT

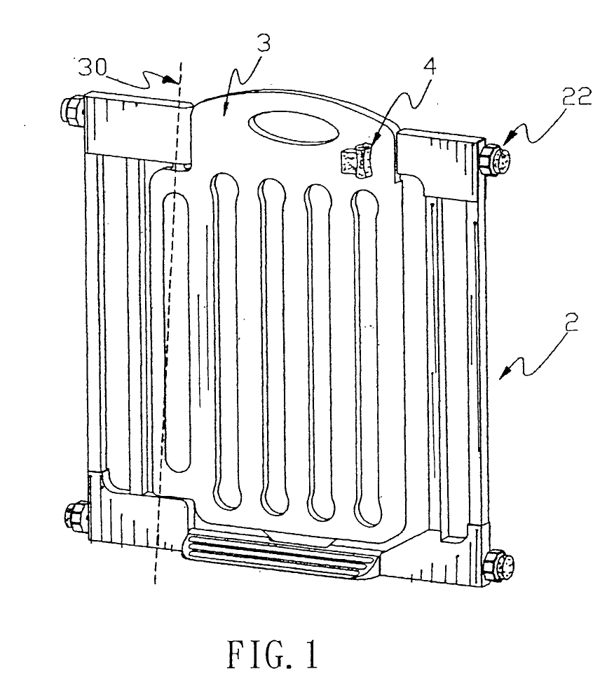

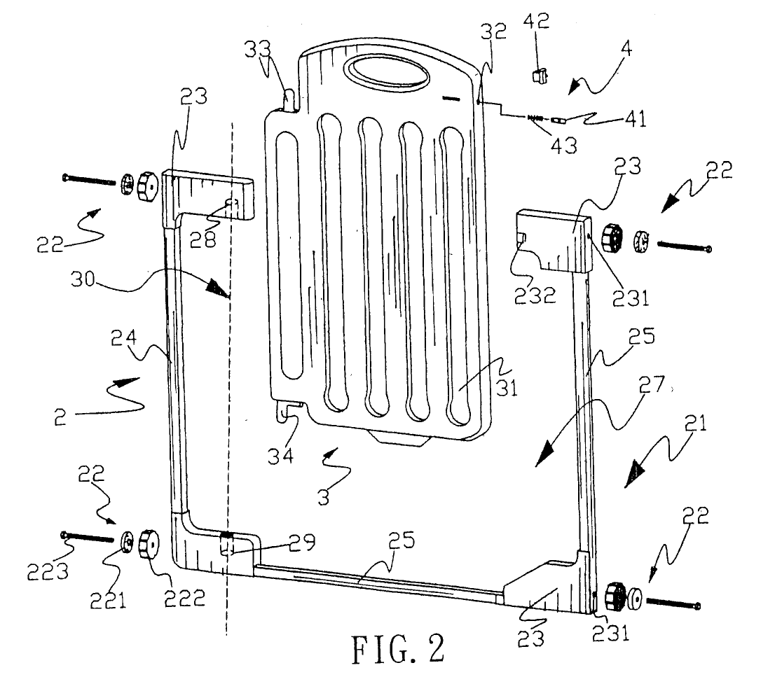

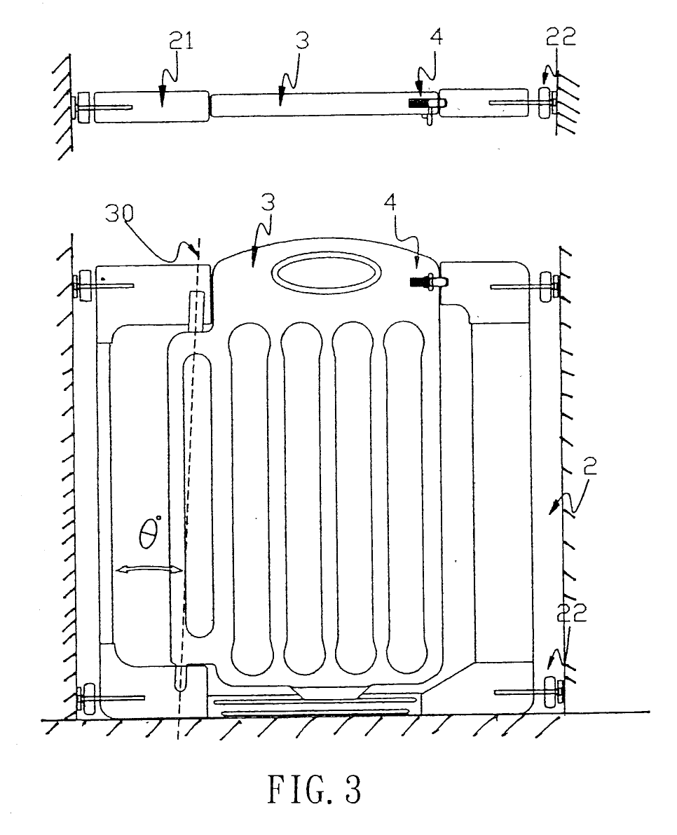

Referring to FIGS. 1, 2 and 3, the automatic closing guarding fence of the invention mainly consists of an anchor frame 2, a door 3 and a release mechanism 4.

The anchor frame 2 mainly includes a frame 21 and a packing structure 22. The frame 21 has a plurality of connection docks 23 connecting respectively to a left post 24, a right post 25 and a base beam 26 to form a housing space 27, which has at least one open end for holding the door. Each connection dock 23 has an outer side with an adjusting screw hole 231 formed thereon. The connection dock 23 located on an upper corner of one side has an inner edge with a latch cavity 232 formed thereon. The connection docks 23 located on the upper corner and the lower corner of the opposing side have respectively an upper pivotal position 28 and a lower pivotal position 29 formed thereon. The axis 30 of the upper pivotal position 28 and the lower pivotal position 29 inclines relative to the left post 24 and the right post 25 of the frame 21.

The packing structure 22 is fastened to the adjusting screw hole 231 on each of the four corners of the frame 21, and includes a packing member 221, an adjusting ring 222 and a bolt 223. The bolt 223 has one end screwed in the adjustable screw hole 231 and another end coupled with the packing member 221, which is made from pliable material. The length of the bolt 223 may be adjusted through the adjusting ring 222 according to the distance between the frame 21 and the two lateral sides of the door frame. The packing member 221 is compressed on the inner side of the door frame to anchor the frame 21 on the inner side of the door frame.

The door 3 is held in the housing space 27 of the anchor frame 2. The door 3 has through slots 31. The door 3 further has one side forming a housing cavity 32 to hold the releasing mechanism 4 and another side with an upper pivotal section 33 and a lower pivotal section 34 to pivotally couple with the upper pivotal position 28 and a lower pivotal position 29 of the frame 21.

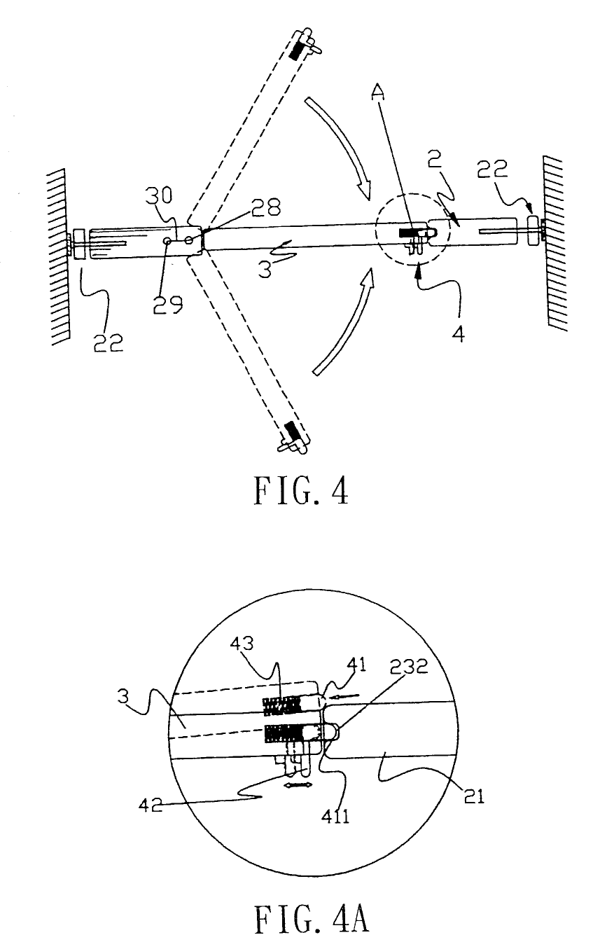

Referring to FIGS. 4 and 4A, the release mechanism 4 is located on one side of the door 3 and includes a latch pin 41, a release knob 42 and an elastic element 43. The latch pin 41 corresponds to the latch cavity 232 of the frame 21. By means of the elastic element 43, the latch pin 41 is positioned between the door 3 and the frame 21 to form a latched state in normal conditions. The release knob 42 may be moved to drive the latch pin 41 away from the latch cavity 232 to release the door 3 for opening. Moreover, the free end of the latch pin 41 forms a sloped surface or an arched surface 411 so that it can form the latched state without the release knob 42 being operated. With a force greater than the elastic element 43, the latch pin 43 may be moved automatically to the direction of the door 3, and engaged with the latch hole 232 to automatically form the latched state.

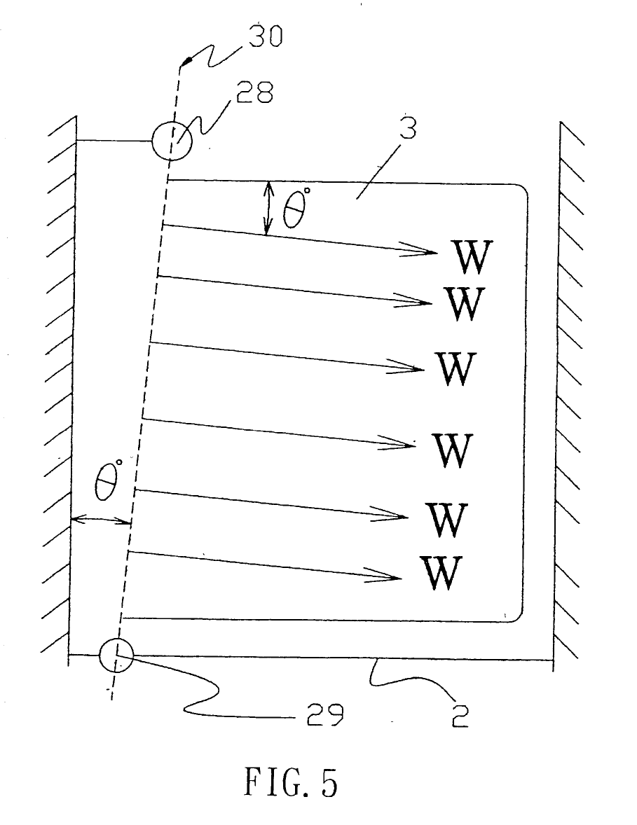

By means of the construction set forth above, when the door 3 is pivotally engaged with the anchor frame 2, the axis 30 of the upper pivotal position 28 and the lower pivotal position 29 inclines at a selected angle, and as the distance between the upper pivotal position 28 and the post of the anchor frame 2 is greater than that of the lower pivotal position 29, the inclined angle increases from the lower side to the upper side. Thus when the door 3 is opened and no external force is applied, the weight of the door generates a biased gravity force (as shown in FIG. 5). Therefore the weight of the door 3 may swing and return the door 3 to the latched position, and the release mechanism 4 generates an automatic latching to form the latched state. As a result, the invention can achieve automatic closing without external force, and the risk of inadvertently leaving the door open and causing dangers to the children may be avoided.

In summary, the invention provides an inclined axis between two pivotal positions to enable the door to return to a closed position due to its own weight without external force. Thus the guarding fence of the invention can prevent accidents that might otherwise occur due to the door being left open inadvertently.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. An automatic closing guarding fence, comprising at least:
an anchor frame having a frame fixedly mounted onto a door opening on a wall, the frame having an upper pivotal position and a lower pivotal position located on one side thereof, the axis connecting the upper pivotal position and the lower pivotal being inclined relative to the frame;
a door having a pair of pivotal sections pivotally coupling with the upper pivotal position and the lower pivotal position to allow the door to close automatically due to its own weight after having been opened; and
a release mechanism for controlling a released and a latched condition between the door and the anchor frame.

2. The automatic closing guarding fence of claim 1, wherein the frame includes a plurality of connection docks, a left post, a right post and a base beam connecting to one another.

3. The automatic closing guarding fence of claim 2, wherein each connecting dock has an outer side with an adjusting screw hole formed thereon.

4. The automatic closing guarding fence of claim 2, wherein the upper pivotal position and the lower pivotal position are located on the connection docks.

5. The automatic closing guarding fence of claim 2, wherein the connection dock has one side forming a latch cavity.

6. The automatic closing guarding fence of claim 1, wherein the release mechanism is located on the door and includes at least a latch pin, a release knob and an elastic element, wherein the latch pin corresponds to the latch cavity and the elastic element maintains the latched condition in normal conditions.

7. The automatic closing guarding fence of claim 1, wherein the anchor frame has a packing structure which includes a bolt, an adjusting ring and a packing member, the bolt being screwed in the adjustable screw hole and the adjusting ring adjusting the length of the bolt.

8. The automatic closing guarding fence of claim 7, wherein the packing member is made from rubber.

9. The automatic closing guarding fence of claim 1, wherein the anchor frame is formed substantially in U-shape.

10. The automatic closing guarding fence of claim 1, wherein the door and the anchor frame are interposed by an elastic element.
